(19) United States
(12) Patent Application Publication
(10) Pub. No.: US 2026/0045165 A1
(43) Pub. Date: Feb. 12, 2026

(54) APPARATUS AND METHOD FOR COOPERATIVE COMMUNICATION BASED ON IMAGE

(71) Applicant: Electronics and Telecommunications Research Institute, Daejeon (KR)

(72) Inventor: Seok Jin LEE, Daejeon (KR)

(73) Assignee: Electronics and Telecommunications Research Institute, Daejeon (KR)

(21) Appl. No.: 19/293,031

(22) Filed: Aug. 7, 2025

(30) Foreign Application Priority Data
Aug. 9, 2024 (KR) 10-2024-0107175
Jul. 31, 2025 (KR) 10-2025-0105046

(51) Int. Cl. G08G 1/00; H04W 4/46; H04W 64/00

(52) U.S. Cl. CPC G08G 1/20; H04W 64/006; H04W 4/46

(57) ABSTRACT

The present invention relates to an apparatus and method for cooperative communication based on an image. The apparatus includes a communication unit configured to perform wireless communication with a cooperative target vehicle performing cooperative driving; and a processor configured to receive cooperative information for the cooperative driving from the cooperative target vehicle through the communication unit and identify the cooperative target vehicle within the image based on a captured image of the cooperative target vehicle and the cooperative information.

### CROSS-REFERENCE TO RELATED APPLICATION

This application claims priority to and the benefit of Korean Patent Application No. 10-2024-0107175 and 10-2025-0105046, filed on Aug. 9, 2024, and Jul. 31, 2025, respectively, the disclosure of which is incorporated herein by reference in its entirety.

### BACKGROUND

### 1. Field of the Invention

The present invention relates to an apparatus and method for cooperative communication based on an image.

### 2. Discussion of Related Art

To maximize the efficiency of the increasing traffic and highway usage recently, the technology of vehicle platooning or cooperative driving, where multiple vehicles drive in a group with very small inter-vehicle distances, is being researched and developed.

A cooperative driving technology (cooperative autonomous driving) of a vehicle is a technology in which multiple vehicles safely and efficiently drive together by exchanging information in real time with each other and road infrastructure. These cooperative target vehicles share information with each other in real time, such as a current location of a vehicle and a predicted direction vector of vehicle movement. This information may help prevent rear-end collisions and help maintain a safe distance between vehicles by sharing current driving speed and brake operation information between leading and following vehicles.

The background art of the present invention is disclosed in Korean Patent Laid-Open Publication No. 10-2017-0053573 (May 16, 2017).

### SUMMARY OF THE INVENTION

The present invention is directed to providing an apparatus and method for cooperative communication based on an image enabling the real-time sharing of driving information between cooperative driving vehicles by designating a cooperative target vehicle in the image with communication identification (ID) based on a captured image and communicating with the cooperative target vehicle.

According to an aspect of the present invention, there is provided an apparatus for cooperative communication based on an image, including: a communication unit configured to perform wireless communication with a cooperative target vehicle performing cooperative driving; and a processor configured to receive cooperative information for the cooperative driving from the cooperative target vehicle through the communication unit and identify the cooperative target vehicle within the image based on a captured image of the cooperative target vehicle and the cooperative information.

The cooperative information may include at least one of communication identification (ID), instantaneous location information, appearance information, and driving information of the cooperative target vehicle.

The instantaneous location information may include at least one of road surface position coordinates of the cooperative target vehicle and a road surface position coordinate measurement time at which the road surface position coordinates are measured.

The appearance information may include at least one of a color, a vehicle body size, a vehicle type, and an exterior component of the cooperative target vehicle.

The processor may use the appearance information to identify the cooperative target vehicle within the image and match the communication ID to the cooperative target vehicle.

The processor may estimate a relative position of the cooperative target vehicle using the instantaneous location information and location information of a host vehicle, extract an appearance of an object in the image based on the relative location, and compare the extracted appearance of the object with the appearance information to identify the cooperative target vehicle among the objects within the image.

The processor may track the cooperative target vehicle within the image to continuously update the communication ID.

The processor may re-match the communication ID to the cooperative target vehicle by identifying the cooperative target vehicle within the image using the appearance information based on whether a preset setting time has elapsed or whether a driving environment of the host vehicle changes.

According to another aspect of the present invention, there is provided a method of cooperative communication based on an image, including: allowing a processor to communicate with a cooperative target vehicle through a communication unit to receive cooperative information for cooperative driving from the cooperative target vehicle; identifying, by the processor, the cooperative target vehicle within the image based on a captured image of the cooperative target vehicle and the cooperative information; and allowing the processor to communicate with the cooperative target vehicle through the communication unit.

The cooperative information may include at least one of communication identification (ID), instantaneous location information, appearance information, and driving information of the cooperative target vehicle.

The instantaneous location information may include at least one of road surface position coordinates of the cooperative target vehicle and a road surface position coordinate measurement time at which the road surface position coordinates are measured.

The appearance information may include at least one of a color, a vehicle body size, a vehicle type, and an exterior component of the cooperative target vehicle.

In the identifying of the cooperative target vehicle within the image, the processor may use the appearance information to identify the cooperative target vehicle within the image and match the communication ID to the cooperative target vehicle.

In the identifying of the cooperative target vehicle within the image, the processor may estimate a relative position of the cooperative target vehicle using the instantaneous location information and location information of a host vehicle, extract an appearance of an object in the image based on the relative location, and compare the extracted appearance of the object with the appearance information to identify the cooperative target vehicle among the objects within the image.

In the identifying of the cooperative target vehicle within the image, the processor may track the cooperative target vehicle within the image to continuously update the communication ID.

In the identifying of the cooperative target vehicle within the image, the processor may re-match the communication ID to the cooperative target vehicle by identifying the cooperative target vehicle within the image using the appearance information based on whether a preset setting time has elapsed or whether a driving environment of the host vehicle changes.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram of an apparatus for cooperative communication based on an image according to an embodiment of the present invention;

FIG. 2 is a conceptual diagram illustrating information sharing between vehicles using the apparatus for cooperative communication based on an image according to an embodiment of the present invention;

FIG. 3 is a conceptual diagram illustrating acquisition of road surface position coordinates according to an embodiment of the present invention;

FIG. 4 is a diagram illustrating an example of matching a communication ID to a cooperative target vehicle according to an embodiment of the present invention;

FIG. 5 is a block configuration diagram of an apparatus for cooperative communication based on an image according to an embodiment of the present invention; and

FIG. 6 is a flowchart of a method of cooperative communication based on an image according to an embodiment of the present invention.

### DETAILED DESCRIPTION OF EXEMPLARY EMBODIMENTS

Hereinafter, an embodiment of an apparatus and method for cooperative communication based on an image according to an embodiment of the present invention will be described. In this process, thicknesses of lines, sizes of components, and the like illustrated in the accompanying drawings may be exaggerated for clearness of explanation and convenience. In addition, terms to be described below are defined in consideration of functions in the present invention and may be construed in different ways according to the intention of users or practice. Therefore, these terms should be defined on the basis of the content throughout the present specification.

However, the present invention may be implemented in various different forms, and is not limited to exemplary embodiments described herein. In the accompanying drawings, portions unrelated to the description will be omitted in order to obviously describe the present invention, and similar reference numerals will be used to describe similar portions throughout the present specification.

Throughout the present specification, unless explicitly described to the contrary, “comprising” any components will be understood to imply the possibility of inclusion of other elements rather than the exclusion of any other elements.

Implementations described herein may be implemented in, for example, a method or process, an apparatus, a software program, a data stream, or a signal. Even when discussed only in the context of a single form of implementation (e.g., discussed only as a method), implementations of the discussed features may also be implemented in other forms (e.g., an apparatus or a program). The apparatus may be implemented in suitable hardware, software, and firmware, and the like. A method may be implemented in an apparatus such as a processor, which generally refers to a computer, a microprocessor, an integrated circuit, a processing device including a programmable logic device, or the like.

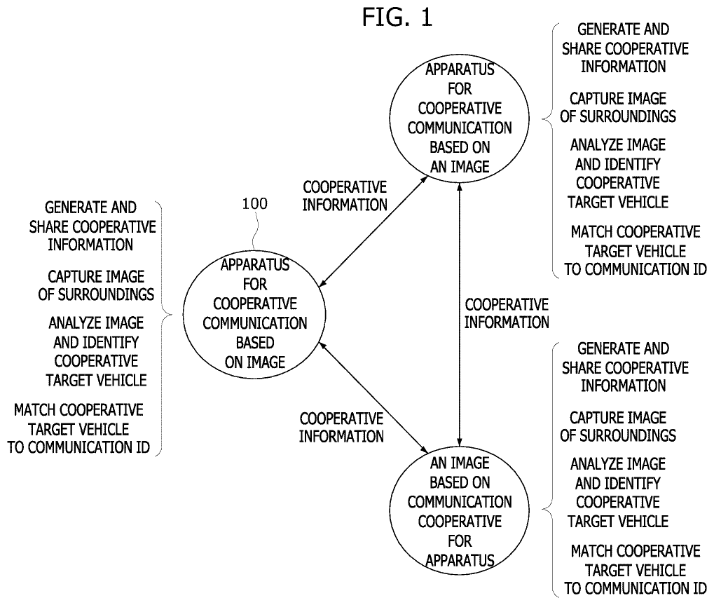

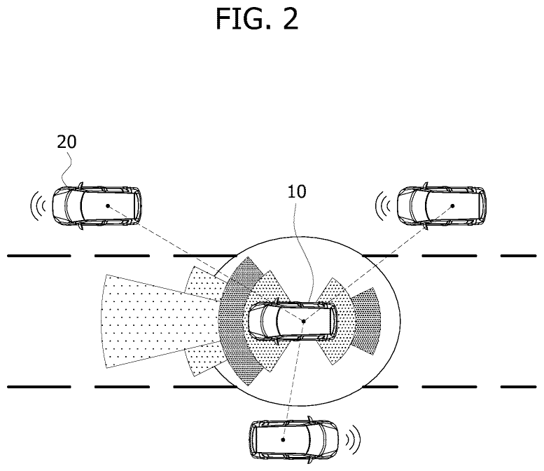

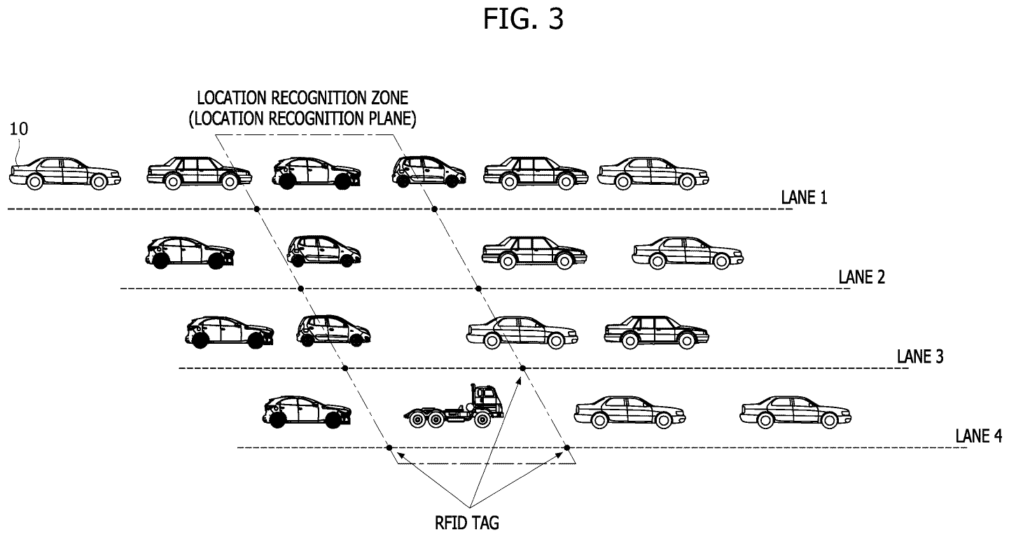

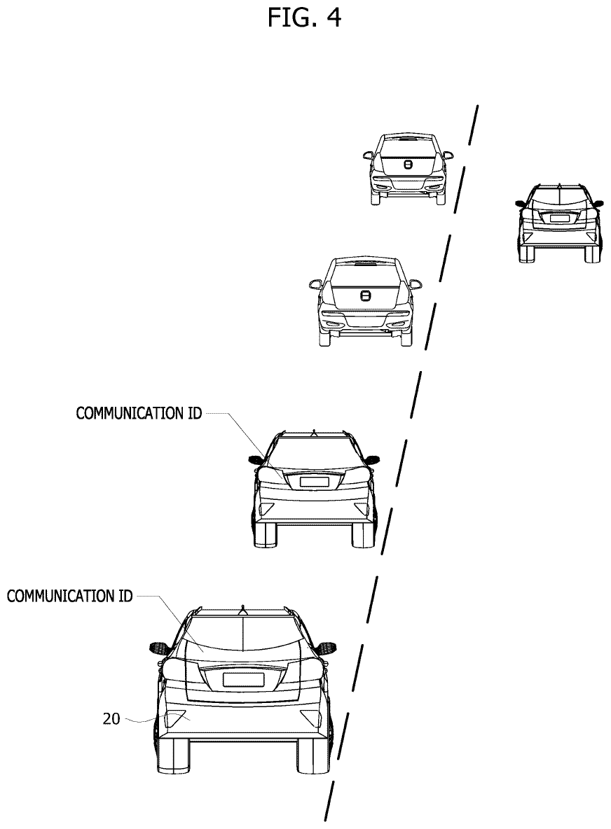

FIG. 1 is a schematic diagram of an apparatus for cooperative communication based on an image according to an embodiment of the present invention, FIG. 2 is a conceptual diagram illustrating information sharing between vehicles using the apparatus for cooperative communication based on an image according to an embodiment of the present invention, FIG. 3 is a conceptual diagram illustrating acquisition of road surface position coordinates according to an embodiment of the present invention, and FIG. 4 is a diagram illustrating an example of matching a communication ID to a cooperative target vehicle according to an embodiment of the present invention.

Referring to FIGS. 1 to 4, an apparatus 100 for cooperative communication based on an image according to an embodiment of the present invention may be mounted on both a host vehicle 10 and a cooperative target vehicle 20 performing cooperative driving. Here, the host vehicle 10 and the cooperative target vehicle 20 may be cooperative driving vehicles performing cooperative driving. For convenience of description, if necessary, the cooperative driving vehicles are divided into the host vehicle 10 and the cooperative target vehicle 20. The description will focus on the apparatus 100 for cooperative communication based on an image of the host vehicle 10.

The cooperative driving vehicle may be a vehicle that drives efficiently by sharing cooperative information in real time with road infrastructure or surrounding vehicles.

The apparatus 100 for cooperative communication based on an image may generate the cooperative information necessary for the cooperative driving of the host vehicle 10 and transmit the generated cooperative information to the cooperative target vehicle 20, thereby sharing the cooperative information with the cooperative target vehicle 20.

The apparatus 100 for cooperative communication based on an image of the cooperative target vehicle 20 may generate the cooperative information based on various pieces of information collected or measured from various vehicle controllers (not illustrated) or sensors (not illustrated) of the host vehicle 10.

Referring to FIG. 2, the apparatus 100 for cooperative communication based on an image may transmit the generated cooperative information to other cooperative target vehicles 20 in the vicinity and receive the cooperative information for the corresponding cooperative target vehicle 20 from the other cooperative target vehicles 20. In this way, each apparatus 100 for cooperative communication based on an image may share cooperative driving information with other cooperative target vehicles 20 in the vicinity.

The cooperative information may include communication identification (ID), instantaneous location information, appearance information, and driving information of the cooperative driving vehicle.

The communication ID may be set for each cooperative driving vehicle for communication between the cooperative driving vehicles.

The instantaneous location information may be current location information of the cooperative driving vehicle. The instantaneous location information may include road surface position coordinates and a road surface position coordinate measurement time of the cooperative driving vehicle.

The road surface position coordinates may be position coordinates of a radio-frequency identification tag (RFID) tag.

Referring to FIG. 3, the RFID tag may be installed on a road surface or a side surface of a road. For example, the RFID tag may be installed in a tunnel, etc., where a Global Positioning System (GPS) signal is not received, but the installation location is not particularly limited.

As the RFID tag is installed at set intervals along each road lane, an RFID reader installed inside the cooperative driving vehicle 20 may read the tag information of the RFID tag while the vehicle drives to determine the location of the cooperative target vehicle 20.

The road surface position coordinate measurement time may be the measurement time for measuring the road surface position coordinates. The road surface position coordinate measurement time may be a GPS reception time for measuring the road surface position coordinates.

In this embodiment, the instantaneous location information is described as road surface position coordinates measured based on the RFID tag. However, the technical scope of the present invention is not limited thereto and may be the location information measured via the GPS signal.

The appearance information may be information for visually identifying the cooperative target vehicle 20. The appearance information may include a color, a vehicle body size, a vehicle type, and exterior components of the cooperative target vehicle 20.

The exterior components may be located outside the cooperative target vehicle 20 to protect the cooperative target vehicle 20, perform specific functions, or perform a design role. For example, the exterior component may include a bonnet (hood), a bumper, a radiator grille, headlamps, rear lamps, fenders, doors, a trunk lid, pillars, a roof, side mirrors, character lines, etc.

The driving information may be information related to the driving of the cooperative target vehicle 20. The driving information may include driving status information, surrounding detection information, traffic and infrastructure information, cooperative control information, security authentication information, etc. For example, the driving status information may include speed, acceleration, a driving direction, a driving plan, etc., of the cooperative target vehicle 20. The surrounding detection information may include recognition information for forward obstacles, pedestrians, etc., road condition information, and weather information. The traffic and infrastructure information may include a traffic light status, intersection information, traffic volume, and emergency alert information. The cooperative control information may include messages regarding situations that require coordination between the cooperative driving vehicles or platooning control information.

The apparatus 100 for cooperative communication based on an image may capture an image of the surrounding environment of the host vehicle 10.

The apparatus 100 for cooperative communication based on an image may identify the cooperative target vehicle 20 within the image based on the captured image of the surrounding environment of the vehicle 10 and the cooperative information of the cooperative target vehicle 20 within the image. That is, the apparatus 100 for cooperative communication based on an image may identify the corresponding cooperative target vehicle 20 within the image using the appearance information as illustrated in FIG. 4 to match the communication ID of the corresponding cooperative target vehicle 20 to each cooperative target vehicle 20.

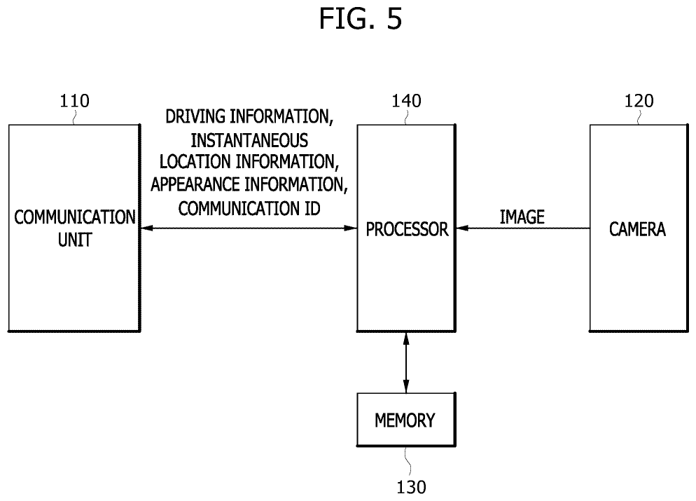

FIG. 5 is a block configuration diagram of an apparatus for cooperative communication based on an image according to an embodiment of the present invention.

Referring to FIG. 5, the apparatus 100 for cooperative communication based on an image may include a communication unit 110, a camera 120, a memory 130, and a processor 140.

The communication unit 110 may transmit and receive the cooperative information between the apparatus 100 for cooperative communication based on an image. For this purpose, the communication unit 110 may use wireless access in vehicular environment (WAVE) as a communication method. In addition, the communication unit 110 may use 3rd Generation Partnership Project (3GPP), Long Term Evolution (LTE), 5^{th} generation (5G), World Interoperability for Microwave Access (WIMAX), wired and wireless Internet, a local area network (LAN), a wireless LAN, a wide area network (WAN), a personal area network (PAN), Bluetooth, wireless fidelity (Wifi), etc.

The camera 120 may capture an image of the surrounding environment of the vehicle. In this case, the camera 120 may capture the image so that the cooperative target vehicle 20 is included in the image. The camera 120 may include, but is not limited to, a charge coupled device (CCD) camera, a complementary metal-oxide semiconductor (CMOS) camera, an infrared camera, a short-wave infrared (SWIR) camera, etc.

The memory 130 may store various data used by the processor 140. The data may include instructions for performing operations, steps, etc., according to embodiments of the present invention. That is, the memory 130 may store instructions for generating the cooperative information about the host vehicle 10, sharing the cooperative information with the cooperative target vehicle 20, and identifying the cooperative target vehicle 20 within the image based on the captured image of the cooperative target vehicle 20 and the corresponding cooperative information.

The memory 130 may include at least one storage medium of a flash memory type, a hard disk type, a multimedia card micro type, a card type memory, a random access memory (RAM), a static random access memory (SRAM), a read-only memory (ROM), a programmable read-only memory (PROM), an erasable programmable read-only memory (EPROM), and an electrically erasable programmable read-only memory (EEPROM).

The processor 140 may be connected to the memory 130 and may execute instructions stored in the memory 130. The processor 140 may execute instructions stored in the memory 130 to control at least one other component (e.g., a hardware or software component) connected to the processor 140 and perform various data processing or calculations.

In addition, the processor 140 may be configured such that its components for performing respective functions are distinguished at the hardware, software, or logic level. In this case, dedicated hardware may be used to perform each function. To this end, the processor 140 may be implemented as at least one of an application specific integrated circuit (ASIC), a digital signal processor (DSP), a programmable logic device (PLD), a field programmable gate array (FPGA), a central processing unit (CPU), microcontrollers, and/or microprocessors, or include at least one of them.

The processor 140 may be implemented as a central processing unit (CPU) or a system on chip (SoC), and may control multiple hardware or software components connected to the processor 140 by running an operating system or application and perform various data processing and calculations. The processor 140 may be configured to execute at least one command stored in the memory 130 and store the execution result data in the memory 130.

The processor 140 may collect the vehicle driving information from the vehicle controller, the sensor, etc., of the host vehicle 10.

The processor 140 may acquire the instantaneous location information on the current road surface from the RFID tag of the host vehicle 10 and extract the instantaneous location information by receiving the GPS reception time from the GPS sensor.

The processor 140 may capture an image of the surrounding environment using the camera 120 of the host vehicle 10. The processor 140 may capture the image so that the cooperative target vehicle 20 sharing the cooperative information is included in the image.

The processor 140 may generate the cooperative information by combining the preset communication ID of the vehicle 20 with the instantaneous location information, the appearance information, and the driving information, and transmit the generated cooperative information to other cooperative target vehicles 20 in the vicinity via the communication unit 110. The processor 140 may receive the cooperative information generated in the same manner from the apparatus 100 for cooperative communication based on an image of other cooperative target vehicles 20 via the communication unit 110. In this way, the processors 140 of each cooperative driving vehicle within a small area may share the cooperative information about the cooperative driving vehicles with each other. Here, the small area may be a relatively narrow space or a limited road section where the cooperative driving occurs.

The processor 140 may identify the cooperative target vehicle 20 within the corresponding image based on the captured image of the cooperative target vehicle 20 and the cooperative information received from the corresponding cooperative target vehicle 20.

Specifically, the processor 140 may estimate the relative position of the cooperative target vehicle 20 centered on the host vehicle 10 using the instantaneous location information of the cooperative target vehicle 20 and the location information of the host vehicle 10.

The processor 140 may extract the appearance (the appearance of the cooperative target vehicle 20 may vary depending on the relative position) of the object within the corresponding image based on the relative position of the cooperative target vehicle 20, and compare the appearance of the extracted object with the appearance information within the cooperative target information of the corresponding cooperative target vehicle 20, thereby identifying one of the objects within the image as the cooperative target vehicle 20. In this case, the processor 140 may pre-store the appearance of the pre-stored object in a database and compare the appearance of the object with the appearance information of the cooperative target information.

When the similarity between the appearance of the object within the image and the appearance information of the cooperative target information is found through the comparison to be greater than or equal to a reference value, the processor 140 may identify the corresponding object within the image as the cooperative target vehicle 20 and match the communication ID received from the cooperative target vehicle 20 to the object within the image, i.e., the cooperative target vehicle 20.

The processor 140 matches the cooperative target vehicle 20 in the image to the communication ID received from the corresponding cooperative target vehicle 20, thereby enabling the communication with the cooperative target vehicle 20 based on the communication ID.

The processor 140 may track the cooperative target vehicle 20 in the image to continuously match the communication ID. To this end, the processor 140 may compare and match the image captured by the camera 120 to previously accumulated images based on the image processing technology for the vehicle appearance identification, thereby estimating the location of the cooperative target vehicle 20 and continuously tracking the cooperative target vehicle 20 using machine learning from the acquired image. In this way, the processor 140 may continuously match the communication ID to the corresponding cooperative target vehicle 20.

Meanwhile, the locations of the host vehicle 10 and the cooperative target vehicle 20 may change, and the relative positions between the vehicles may continuously change. That is, since the instantaneous position coordinates of the host vehicle 10 or the cooperative target vehicle 20 continuously change during driving, and the image captured by the host vehicle 10 also continuously changes, the processor 140 should continuously update the communication ID within the image.

To this end, the processor 140 may first determine whether a preset update condition for updating the communication ID is satisfied. In this case, the processor 140 may determine whether a preset time has elapsed since the communication ID was matched with the cooperative target vehicle 20 within the image, or whether the driving environment of the host vehicle has changed. Here, the driving environment may include changes in the position of the host vehicle due to the driving of the cooperative target vehicle 20.

When the update conditions are met, the processor 140 may identify the cooperative target vehicle 20 within the image using the appearance information within the cooperative information received from the cooperative target vehicle 20 and re-match the communication ID to the cooperative target vehicle 20. In addition, based on the image processing technology for vehicle appearance identification described above, the processor 140 may compare and match the images captured by the camera 120 with the previously accumulated images to estimate the location of the cooperative target vehicle 20 and continuously track the cooperative target vehicle 20 through the machine learning from the acquired images, thereby continuously re-matching the corresponding cooperative target vehicle 20 to the communication ID.

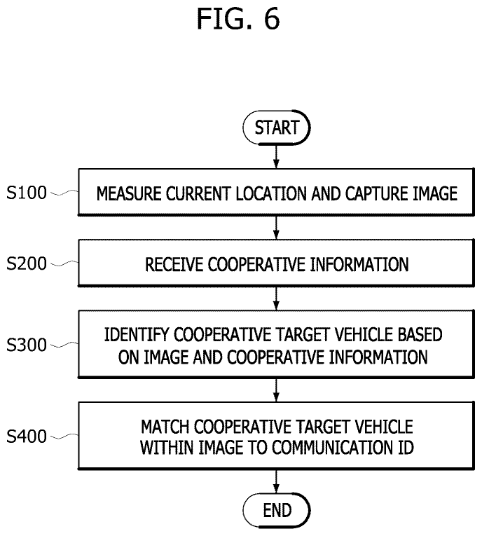

Hereinafter, a method of cooperative communication based on an image according to an embodiment of the present invention will be described in detail with reference to FIG. 6.

FIG. 6 is a flowchart of a method of cooperative communication based on an image according to one embodiment of the present invention.

Referring to FIG. 6, the processor 140 may acquire the instantaneous location information on the current road surface from the RFID tag and extract the instantaneous location information by receiving the GPS reception time from the GPS sensor. In addition, the processor 140 may capture an image of the surrounding environment using the camera 120 (S100).

In addition, the processor 140 may collect the vehicle driving information from the vehicle controller, the sensor, etc., of the host vehicle 10.

The processor 140 combines the communication ID of the host vehicle 10 with the instantaneous location information, the appearance information, and the driving information to generate the cooperative information and transmit the generated cooperative information to a nearby cooperative target vehicle 20 via the communication unit 110. The processor 140 may receive the cooperative information from the apparatus 100 for cooperative communication based on an image of the cooperative target vehicle 20 via the communication unit 110 (S200).

The processor 140 may identify the corresponding cooperative target vehicle 20 within the image based on the captured image of the cooperative target vehicle 20 and the cooperative information received from the cooperative target vehicle 20 (S300). Specifically, the processor 140 may estimate the relative position of the cooperative target vehicle 20 centered on the host vehicle 10 using the instantaneous location information of the cooperative target vehicle 20 and the location information of the host vehicle 10.

The processor 140 may extract the appearance of an object within the image based on the relative position and compare the appearance of the extracted object with the appearance information of the cooperative information of the cooperative target vehicle 20, thereby identifying one of the objects within the corresponding image as the cooperative target vehicle 20.

Subsequently, the processor 140 may match the object within the image, i.e., the cooperative target vehicle 20, to the communication ID received from the corresponding cooperative target vehicle 20 (S400).

Accordingly, the processor 140 may communicate with the cooperative target vehicle 20 using the corresponding communication ID.

Meanwhile, the processor 140 may track the cooperative target vehicle 20 within the image. During this process, the processor 140 may determine whether the update conditions are satisfied. That is, when the set amount of time has elapsed since the communication ID was matched to the cooperative target vehicle 20 within the image or the driving environment of the host vehicle has changed, the processor 140 may identify the corresponding cooperative target vehicle 20 within the image using the appearance information of the cooperative information received from the cooperative target vehicle 20 to re-match the communication ID to the cooperative target vehicle 20. In addition, based on the image processing technology for vehicle appearance identification, the processor 140 may compare and match the images captured by the camera 120 with the previously accumulated images to estimate the location of the cooperative target vehicle 20 and continuously track the cooperative target vehicle 20 through the machine learning from the acquired images, thereby continuously re-matching the corresponding cooperative target vehicle 20 to the communication ID.

In this way, according to the apparatus and method for cooperative communication based on an image according to an embodiment of the present invention, the cooperative target vehicle 20 in the image may be matched to the corresponding communication ID based on the image captured by the host vehicle 10 to designate the cooperative target vehicle 20, thereby enabling the real-time sharing of the driving information between the vehicles.

In addition, according to the apparatus and method for cooperative communication based on an image according to an embodiment of the present invention, by supporting the wireless communication for the driving cooperation between the vehicles on the basis of an image, it is possible to increase the road utilization of the vehicle and improve vehicle safety.

In addition, according to the apparatus and method for cooperative communication based on an image according to an embodiment of the present invention, by designating the cooperative target vehicle with the wireless communication address to share the information, it is possible to support platooning in the autonomous driving system.

Although the present invention has been described with reference to embodiments shown in the accompanying drawings, they are only examples. It will be understood by those skilled in the art that various modifications and other equivalent exemplary embodiments of the present invention are possible. Accordingly, the technical scope of the present invention is to be determined from the spirit of the appended claims.

What is claimed is:

1. An apparatus for cooperative communication based on an image, comprising:
a communication unit configured to perform wireless communication with a cooperative target vehicle performing cooperative driving; and
a processor configured to receive cooperative information for the cooperative driving from the cooperative target vehicle through the communication unit and identify the cooperative target vehicle within the image based on a captured image of the cooperative target vehicle and the cooperative information.

2. The apparatus of claim 1, wherein the cooperative information includes at least one of communication identification (ID), instantaneous location information, appearance information, and driving information of the cooperative target vehicle.

3. The apparatus of claim 2, wherein the instantaneous location information includes at least one of road surface position coordinates of the cooperative target vehicle and a road surface position coordinate measurement time at which the road surface position coordinates are measured.

4. The apparatus of claim 2, wherein the appearance information includes at least one of a color, a vehicle body size, a vehicle type, and an exterior component of the cooperative target vehicle.

5. The apparatus of claim 2, wherein the processor uses the appearance information to identify the cooperative target vehicle within the image and match the communication ID to the cooperative target vehicle.

6. The apparatus of claim 5, wherein the processor estimates a relative position of the cooperative target vehicle using the instantaneous location information and location information of a host vehicle, extracts an appearance of an object in the image based on the relative location, and compares the extracted appearance of the object with the appearance information to identify the cooperative target vehicle among the objects within the image.

7. The apparatus of claim 5, wherein the processor tracks the cooperative target vehicle within the image to continuously update the communication ID.

8. The apparatus of claim 5, wherein the processor re-matches the communication ID to the cooperative target vehicle by identifying the cooperative target vehicle within the image using the appearance information based on whether a preset setting time has elapsed or whether a driving environment of the host vehicle changes.

9. A method of cooperative communication based on an image, comprising:
allowing a processor to communicate with a cooperative target vehicle through a communication unit to receive cooperative information for cooperative driving from the cooperative target vehicle;
identifying, by the processor, the cooperative target vehicle within the image based on a captured image of the cooperative target vehicle and the cooperative information; and
allowing the processor to communicate with the cooperative target vehicle through the communication unit.

10. The method of claim 9, wherein the cooperative information includes at least one of communication identification (ID), instantaneous location information, appearance information, and driving information of the cooperative target vehicle.

11. The method of claim 10, wherein the instantaneous location information includes at least one of road surface position coordinates of the cooperative target vehicle and a road surface position coordinate measurement time at which the road surface position coordinates are measured.

12. The method of claim 10, wherein the appearance information includes at least one of a color, a vehicle body size, a vehicle type, and an exterior component of the cooperative target vehicle.

13. The method of claim 10, wherein, in the identifying of the cooperative target vehicle within the image, the processor uses the appearance information to identify the cooperative target vehicle within the image and match the communication ID to the cooperative target vehicle.

14. The method of claim 13, wherein, in the identifying of the cooperative target vehicle within the image, the processor estimates a relative position of the cooperative target vehicle using the instantaneous location information and location information of a host vehicle, extracts an appearance of an object in the image based on the relative location, and compares the extracted appearance of the object with the appearance information to identify the cooperative target vehicle among the objects within the image.

15. The method of claim 13, wherein, in the identifying of the cooperative target vehicle within the image, the processor tracks the cooperative target vehicle within the image to continuously update the communication ID.

16. The method of claim 13, wherein, in the identifying of the cooperative target vehicle within the image, the processor re-matches the communication ID to the cooperative target vehicle by identifying the cooperative target vehicle within the image using the appearance information based on whether a preset setting time has elapsed or whether a driving environment of the host vehicle changes.
